(19) United States
(12) Patent Application Publication
(10) Pub. No.: US 2015/0347506 A1
(43) Pub. Date: Dec. 3, 2015

(54) METHODS AND APPARATUS FOR SPECIFYING QUERY EXECUTION PLANS IN DATABASE MANAGEMENT SYSTEMS

(71) Applicant: Tesora, Inc., Cambridge, MA (US)

(72) Inventors: Mrithyunjaya Annapragada, Bolton, MA (US); Benjamin Rousseau, Somerville, MA (US)

(73) Assignee: Tesora, Inc., Cambridge, MA (US)

(21) Appl. No.: 14/288,591

(22) Filed: May 28, 2014

(51) Int. Cl. G06F 17/30

(52) U.S. Cl. CPC G06F 17/30463

(57) ABSTRACT

A database management system (DBMS) in which a user can express a query plan as a Raw Plan of arbitrary complexity in a format that can be executed by the DBMS. The user may also specify criteria under which this Raw Plan is to be executed. When a matching query and the subject circumstances are encountered the DBMS will execute the Raw Plan, instead of searching in a query cache or generating a new query plan.

### CROSS-REFERENCE TO RELATED APPLICATIONS

The present application is related to the following commonly assigned U.S. patent application Ser. No. 13/906,556, which was filed on May 31, 2013, by Annapragada et al. for an “Adaptive Multi-Client Saas Database” and Attorney Docket Number 111055-0004, filed on the same date herewith entitled “Hierarchical Query Plans In An Elastic Parallel Database Management System” also by Annapragada et al., both of which are hereby incorporated by reference in their entirety.

### BACKGROUND OF THE INVENTION

1. Field of the Invention

This patent relates generally to query planning in data management systems.

2. Background Information

Relational Database Management Systems are sometimes referred to as RDBMS. In RDBMS', data are stored in tables and users are able to “query” that data using queries which are submitted to the RDBMS by client applications (often referred to simply as “clients”). The Structured Query Language (SQL) is an example of a query language understood by RDBMS.

In the execution of queries the RDBMS inspects the query for syntactical correctness and upon successful verification of correctness, the query is processed by a series of components that determine how to execute the query. Typical RDBMS implement these steps with query parsers, query optimizers and query executors to verify, interpret, plan and execute queries.

In the process of executing queries, RDBMS construct “Query Plans”. A “Query Plan” is an ordered list of operations that must be performed in response to a query, in order to produce the intended effect of the query. The process of query planning and optimization are complex because they have to address a wide variety of different kinds of queries and circumstances. There are occasions when the Query Plan chosen by an RDBMS is not optimal, for one of a very large number of possible reasons.

A particular class of RDBMS systems is the Parallel RDBMS (PRDBMS), a system where user data are partitioned across a plurality of computers (called nodes), each providing computing capacity (CPU), volatile memory, network connectivity and storage, and whereby queries are collectively executed by this collection of computers.

The data stored by the DBMS may be stored in some persistent storage medium (such as hard disk drives or solid state drives) or may be stored in some ephemeral memory storage medium such as a RAM-disk.

A PRDBMS is a specific instance of a distributed computing system. According to the sharing of resources such as CPU, volatile memory, and storage, these systems are categorized as Shared Nothing, Shared Disk, Shared Memory, or Shared Everything systems.

In PRDBMS systems that are Shared Nothing, query execution is further complicated by the fact that each node only has visibility to a subset of the data. For example, in Shared Nothing PRDBMS each node only has access to the data on the storage associated with that node. Query planning in a PRDBMS must also take into account issues relating to data visibility and data location.

The complexity of query planning in PRDBMS is therefore significantly higher and the possibility for a sub-optimal or incorrect query plans is increased.

Often query planners take some direction from metadata and statistics that are accumulated by the DBMS over time. Such metadata often includes table sizes, key distribution values, schema information such as available indices, and various constraints established in the data model such as uniqueness and referential integrity relationships.

A variety of methods have been proposed to influence the Query Plans constructed by an RDBMS. All of these can be broadly categorized as “hints” to the RDBMS; suggestions from the client application that provide the RDBMS with information that may not be otherwise available to it, and that the client believes to be important in the query planning process. These hints must be specified with the query on each execution. Hints sometimes include a specification of a particular access methods (such as indexes), or join orders.

The software and algorithms for generating query plans can be provided these hints as described in a variety of items of prior art but all of these mechanisms allow the query planning software to construct a query plan within the parameters established by the hints. However, despite the hints, there are circumstances where the query planning process chooses sub-optimal query plans.

In query planning, especially in the case of PRDBMS it is sometimes required to specify a particular query execution plan in response to a query. This can occur for one of many reasons including the fact that no legitimate code path in the query planner would, in the specific circumstances elect to execute a particular query in a manner that the user would like it to be executed.

In the general case, manually constructing a query plan for a non-trivial query is extremely complicated and not practical. This complexity is only compounded when one considers that query languages (including SQL) provide the ability to specify parameters. The two queries below are semantically identical and differ only in the parameters provided therein.

### Query A:

SELECT * FROM USERS WHERE USERID=40;

### Query B:

SELECT * FROM USERS WHERE USERID=35;

Yet there exist cases where it is essential that the DBMS execute a very specific query plan, and one that it would not itself choose as the query plan for the query at hand. DBMS traditionally plan and execute queries in a manner that is graphically represented in FIG. 1 (this is prior art). The input query (101) is first parsed (102) for syntactical and semantic validness. If found to be valid, a Query Plan (103) is constructed and then executed (104) and this concludes the query execution process (105).

Also DBMS traditionally provide a mechanism to retrieve query plans as represented in FIG. 2 (this is prior art). The input query (201) is parsed (202) and if found to be semantically and syntactically valid, submitted to a query planner and a Query Plan (203) is constructed and the Query Plan is returned to the user (204) which concludes the process (205).

### SUMMARY OF THE INVENTION

A mechanism is presented whereby a user can construct a query plan for a query of arbitrary complexity and then express that query plan in a format that can be provided to the DBMS. The query plan provided to the system in this form is referred to as a Raw Plan.

In specifying the Raw Plan to the system, the user may also specify the criteria under which this raw plan is to be executed. When a matching query and the subject circumstances are encountered the DBMS will execute the Raw Plan in response to that query, instead of searching in a query cache or generating a new query plan if one is not found in a query cache.

### BRIEF DESCRIPTION OF THE DRAWINGS

The invention description below refers to the accompanying drawings, of which:

FIG. 1 provides a graphical representation of the normal query execution process.

FIG. 2 provides a graphical representation of the process for obtaining a query plan from the system.

FIG. 3 provides a graphical representation of the steps for specifying a Raw Plan to the system.

FIG. 4 provides a graphical representation of the query execution process in a system according to the preferred embodiments.

FIG. 5 provides a graphical representation of the steps in enabling and disabling Raw Plans.

FIG. 6 provides a graphical representation of a parallel database.

FIG. 7 provides a graphical representation of a DBMS.

FIG. 8 illustrates the process of query planning (103, 203 or 404).

FIG. 9 provides a description of some tables and queries used in subsequent illustrations.

FIG. 10 illustrates EXPLAIN PLAN output used for RAW PLAN generation.

FIG. 11 illustrates EXPLAIN PLAN output used for RAW PLAN generation.

FIG. 12 illustrates EXPLAIN PLAN output used for RAW PLAN generation.

FIG. 13 illustrates a sequence of commands to store a raw plan, list raw plans, to alter a raw plan and to delete a raw plan.

FIG. 14 illustrates an example Raw Plan.

### DETAILED DESCRIPTION OF AN ILLUSTRATIVE EMBODIMENT

Some examples of when it would be beneficial to provide a mechanism whereby a client application could force a specific query plan are provided first.

The data stored in databases is often highly privileged and often contains personally identifiable information about people. Companies that own this data are reluctant to share this with others, especially software vendors. In some countries and in some situations, the owners of the data may not be permitted to share the data with others.

On occasion, bugs in software cause query execution to go wrong, but only when a specific query plan is executed. When a customer reports this problem to a vendor, the vendor is often unable to recreate the problem because sample data is not provided with the problem report. Therefore, in the absence of the data set that created the problem, the vendor is unable to replicate the problem as no amount of hints or other trickery can cause the query planner to emit the particular aberrant query plan.

In another circumstance, the RDBMS when presented with a particular query analyzed it and generated what appeared to be a perfectly valid query plan. However the data against which this query was executed was peculiar in some way that could not be captured in the metadata and statistics and therefore the query plan constructed was particular bad and resulted in the system taking unacceptably long to execute the query. A visual inspection of the query and some elementary debugging showed the problem and a user felt that if the system were only to execute a slightly different query plan, it would be much quicker. The user was able to infer this by a logical process of manually computing the various steps in this proposed query plan and estimating the total time that the query would take to execute but the user was unable to provide any hints to the query planner to cause it to generate the plan that was desired.

In another circumstance, the RDBMS when presented with a particular query analyzed it and generated a perfectly functional and efficient query plan that also executed very quickly. However when a very similar query differing from the first one only in the parameters is executed the specific data lead to a highly sub-optimal query execution plan.

In all of these situations a mechanism to force a specific query plan is essential.

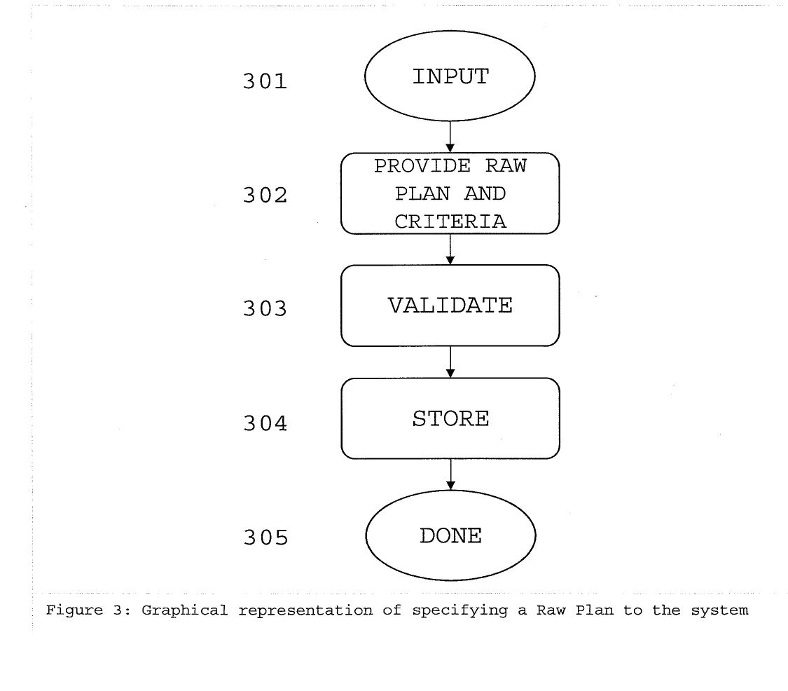

A DBMS according to the preferred embodiments herein provides a mechanism for a client application to provide the DBMS with a Raw Plan as illustrated in FIG. 3. The Input (301) consists of a Raw Plan and Criteria specification (302) which is validated by the system (303) and if valid is stored (304) in a Raw Plan cache which completes the process (305).

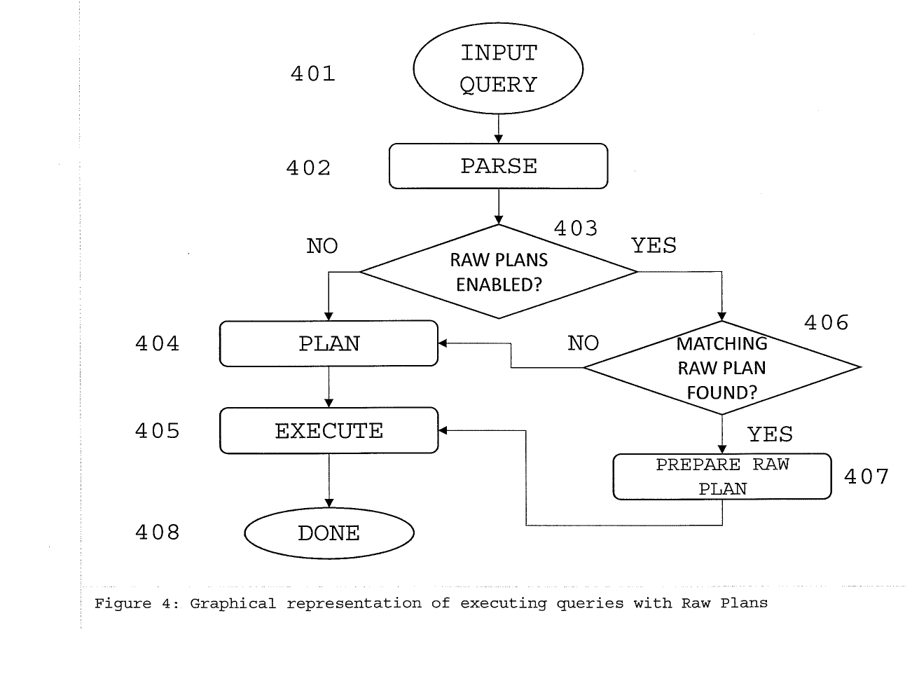

A DBMS according to the preferred embodiments follows a process for query execution as illustrated in FIG. 4. In response to an Input Query (401) from a client application, the query is parsed for syntactic and semantic validation (402). If valid, the system checks to see if Raw Plan support is enabled (403). If not the system proceeds to Plan the query (404) and then execute it (405) which would complete the process (408). However if (403) determines that Raw Plan support is enabled the system inspects the Raw Plan cache to find a matching Raw Plan (406) for the Input Query according to criteria specified along with each Raw Plan known to the system. If none is found, the system resumes with the Query Planning Process (404) and proceeds to execute (405) that plan which would complete the process (408). However, if a matching Raw Plan is found (406) then that Raw Plan is prepared for execution (407) and then executed (405) which would conclude the process (408).

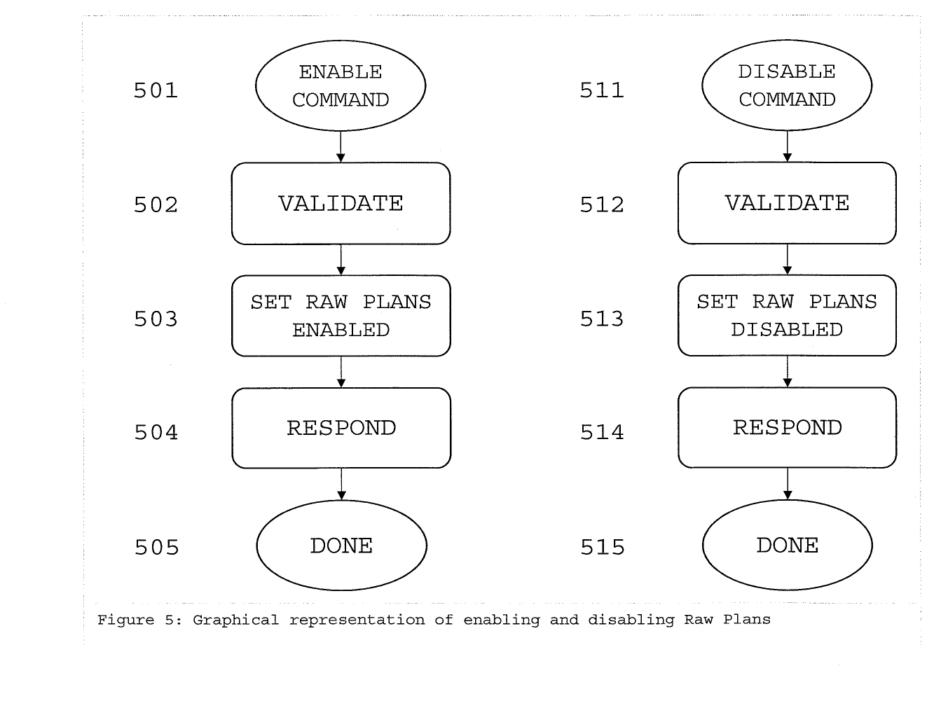

The decisions about how to plan a query are based on the settings that indicate whether or not Raw Plans are enabled. FIG. 5 shows the steps for enabling and disabling this capability in a DBMS according to the preferred embodiments. An Enable Command (501) is received from a client application and is Validated (502). If it is valid then the system records the fact that Raw Plans are now enabled (503) in some manner and responds (504) to the client application which completes the process (505). When a Disable Command (511) is received from a client application and is Validated (512). If it is valid then the system records the fact that Raw Plans are now disabled (513) in some manner and responds (514) to the client application which completes the process (515).

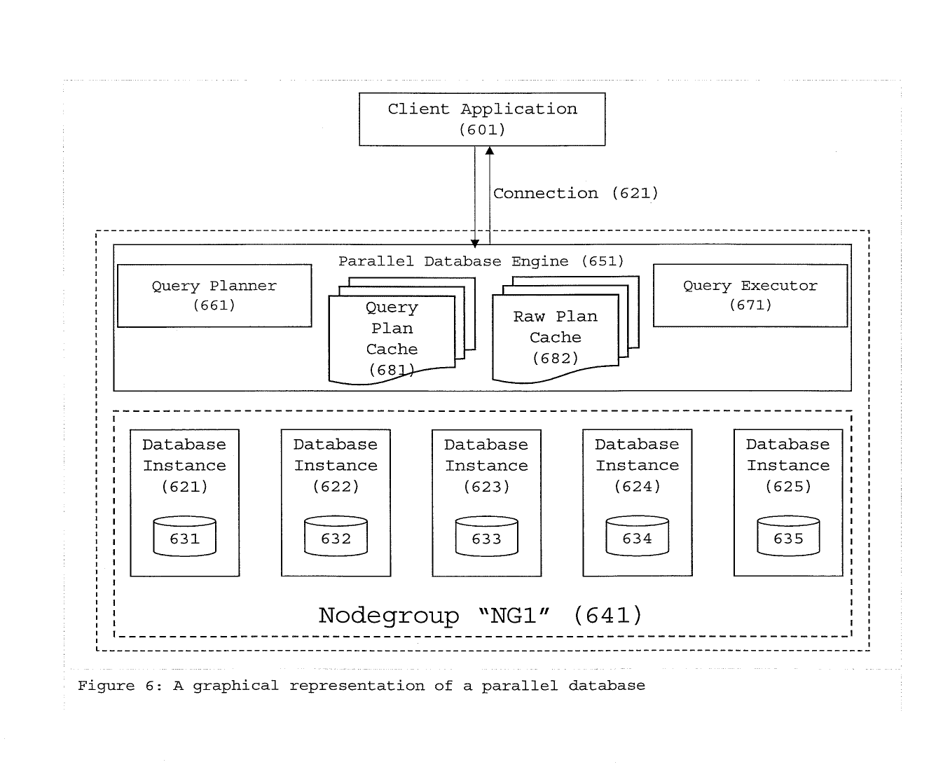

FIG. 6 provides a graphical representation of a parallel database. A client application (601) establishes a connection (621) to the Parallel Database Engine (651) which consists of a Query Planner (661) and a Query Executor (671), a Query Plan Cache (681) and a Raw Plan Cache (682). Data are stored on Database Instances (621, 622, 623, 624, and 625) which each have access to storage (631, 632, 633, 634 and 635) and whereby database instances are grouped together into Nodegroups (641).

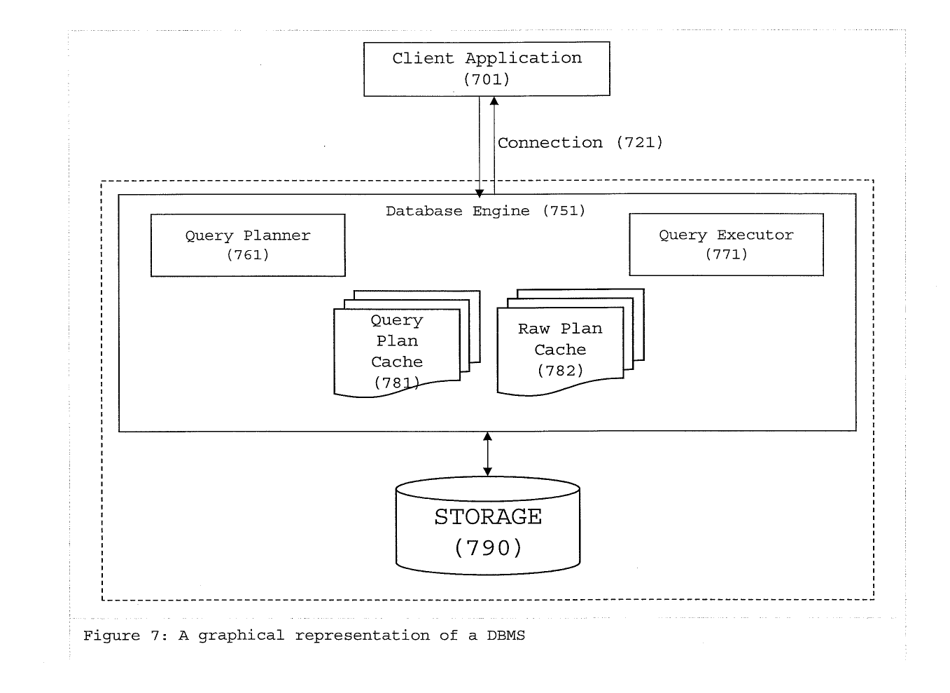

FIG. 7 provides a graphical representation of a DBMS. A client application (701) establishes a connection (721) to the Database Engine (751) which consists of a Query Planner (761) and a Query Executor (771), a Query Plan Cache (781) and a Raw Plan Cache (782). Data are stored on Storage (790).

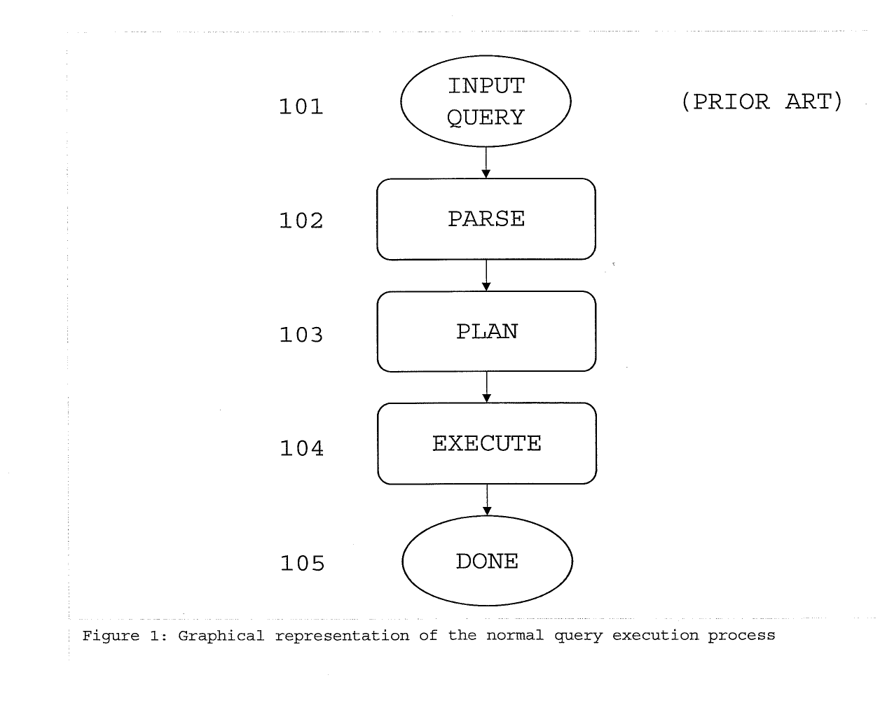

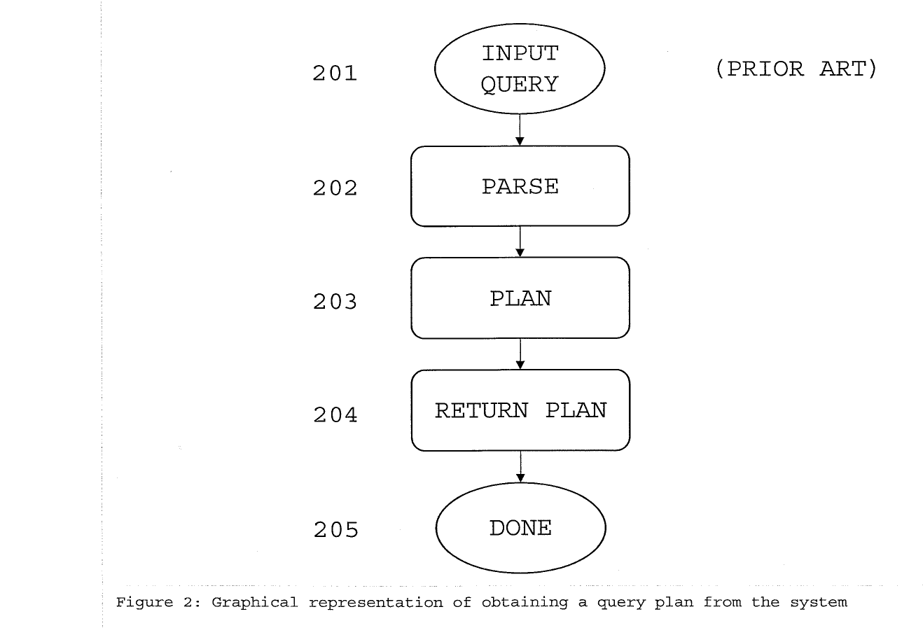

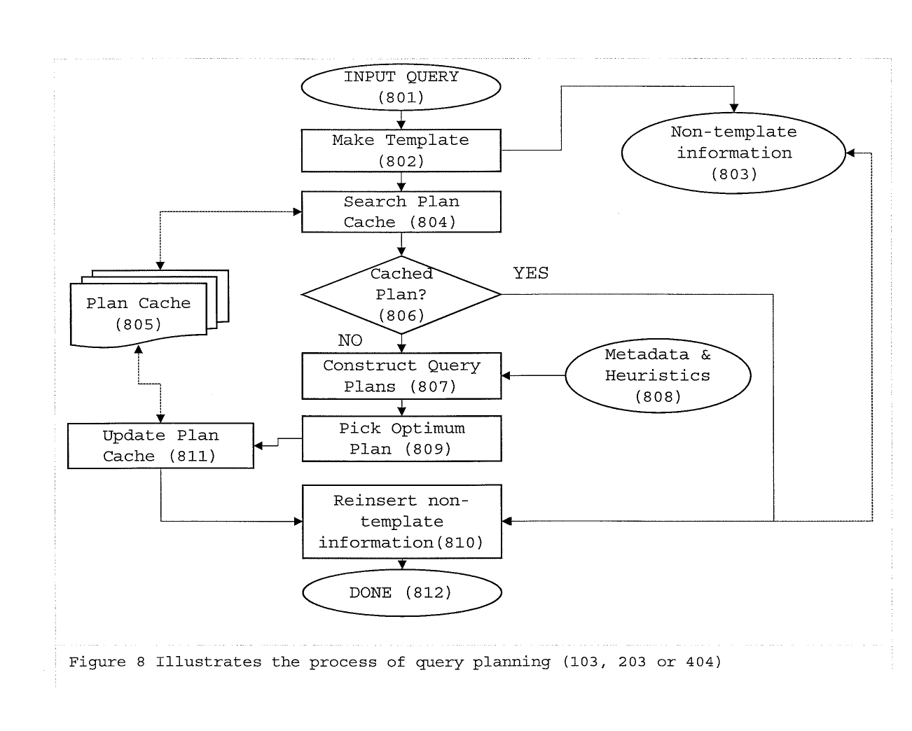

In FIGS. 1, 2 and 4, items 103, 203 and 404 represent the Query Planning step. FIG. 8 illustrates the process of query planning in more detail.

Several database queries are considered equivalent by the system for the purpose of query planning. For example, Query A and Query B below are equivalent as they differ only in the parameter (the userid) that is being searched.

### Query A:

SELECT * FROM USERS WHERE USERID=40;

### Query B:

SELECT * FROM USERS WHERE USERID=35;

For the purpose of query planning, we consider a “Template” to be a representation of a query such that a query plan constructed for the template of a query can be recombined with the non-template information to produce an executable query plan. Using this technique, one could construct the following Template and Non-Template Information. Template:

SELECT * FROM USERS WHERE USERID=<PARAMETER1>;

### Non-Template Information:

Parameter 1: Integer

FIG. 8 illustrates query planning 404 of FIG. 4 in more detail. This process is followed regardless of whether the selected plan (e.g., that derived from the parsed original query selected as a result of the “no” decision from steps 403 or 406) or the Raw Plan (e.g., that selected per step 407) is chosen for planning. An input query (801) is first passed through a template generation operation (802) which results in the generation of non-template information (803) which is set aside, and a template which is passed on to the next step. The Plan Cache (805) is searched for a match to the template just generated (804). If a Cached Plan is found (806) processing continues at step (810). If a Cached Plan is not found processing continues to step (807).

If a cached plan is not found in (806), a set of feasible query plans are constructed (807) based on Metadata & Heuristics (808). The optimum plan is chosen based on some specified optimization parameters (809) and the plan cache is updated (811) to reflect this optimum plan for the template generated in (802). Non-template information that was extracted in step (802) is now reinserted (810) into the query plan and the process of query planning is done (812).

If a cached plan is found in (806), processing resumes at step (810) where the non-template information is reinserted into the query plan obtained from cache, and the process of query planning is done (812).

As you can see from the above, the query cache contains a cache of Query Templates and their associated Query Plans constructed in step (809) above. One purpose of a query plan cache is to save time and resources in the query planning process.

Returning attention to FIG. 4, step (406) thus searches the raw plan cache in the raw plan cache (682 or 782) and the process of searching the raw plan cache is performed on the template of the query. The process (407) of preparing the raw plan includes reinserting all the non-template information into the plan found in the raw plan cache.

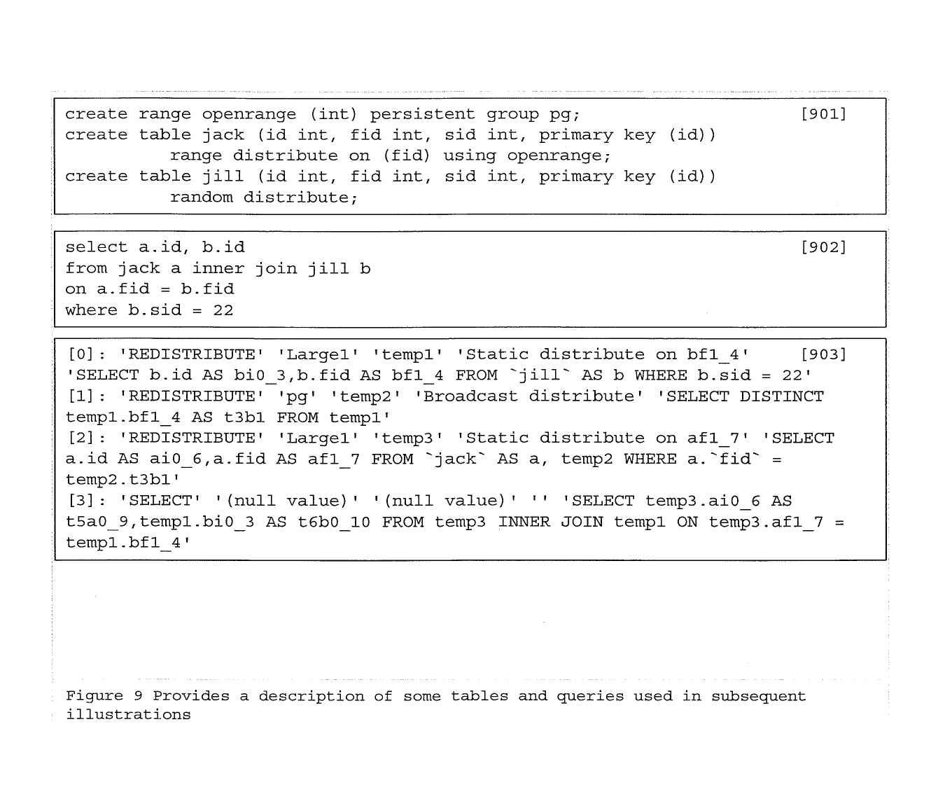

FIG. 9 shows some sample tables, ‘jack’ and ‘jill’ (901) which are queried (902) and the query plan for this query is shown (903). Based on the data distribution and schema of the tables in (901), the join between the tables in (902) results in some redistributions as illustrated in (903).

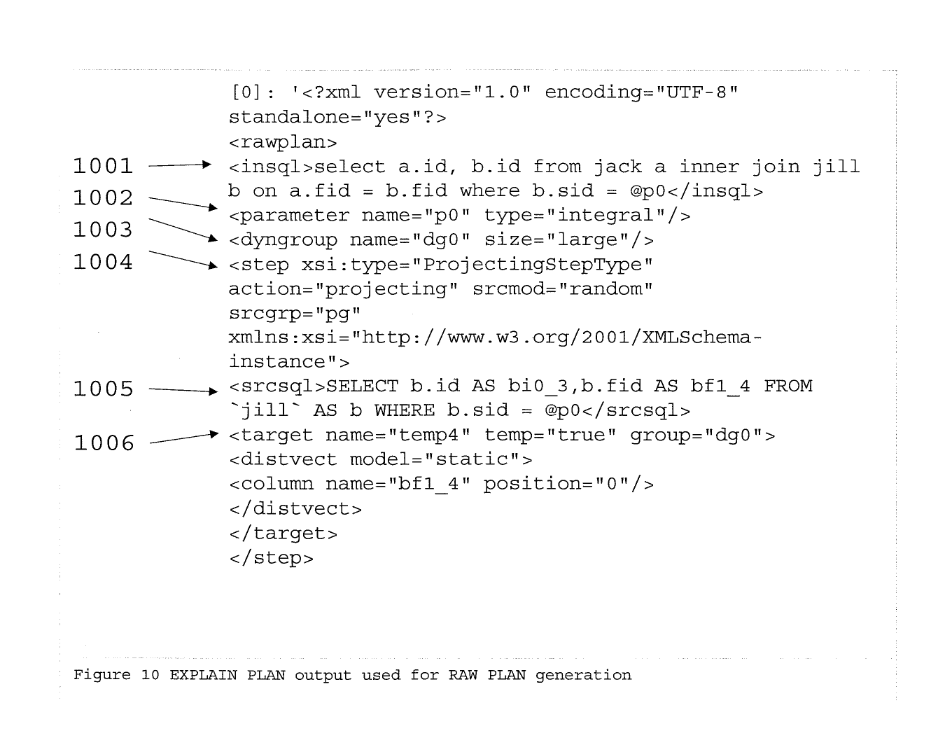

Using an EXPLAIN command with the “RAW PLAN=TRUE” qualifier, the user obtained a raw plan for the query (902) that is shown in FIGS. 10, 11 and 12.

The Raw Plan in this representation uses XML and the incoming SQL Template that is the subject of this plan is illustrated with the <insql> XML tag (1001). The Template generation process identified one non-template item, a parameter and that is called out as such (1002) with the <parameter> XML tag. The Query Plan illustrated has multiple steps and one of the steps performs an operation that requires the use of a Dynamic Nodegroup which is, for the purpose of this Raw Plan, identified as “dg0” (1003) and identified using the “dyngroup” XML tag. The Query Plan consists of multiple steps and the first step of the Query Plan (1004) consists of a query identified by the “srcsql” XML tag (1005). Observe that this step uses a query with the parameter @p0 which is the Non-Template information (1002). It performs a redistribution (1006) where the target is temp4 which is a table on a nodegroup dg0 which was the Dynamic Group (1003). The definition of the storage group dg0 (1003) provides a qualifier (size=“large”) which is used at run time to map dg0 onto an actual storage group that matches the qualifier (size=“large”). The name “dg0” is used within the raw plan to identify this storage group for use in the various Query Plan Steps.

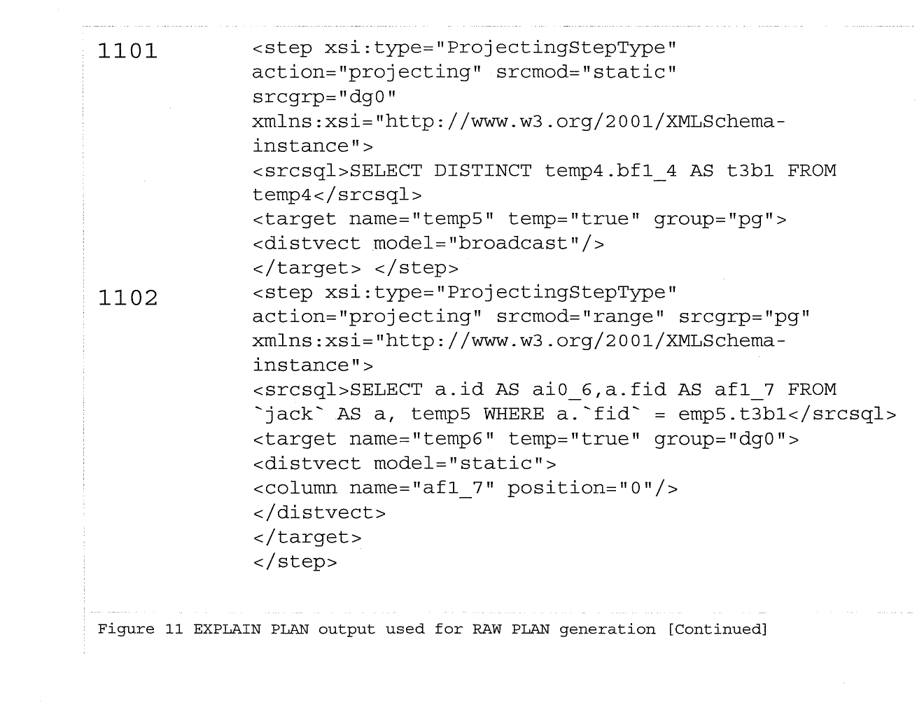

FIG. 11 shows two more steps (1101) and (1102). Observe that this step performs a redistribution and sends the result to a table on the persistent group using a broadcast distribution model.

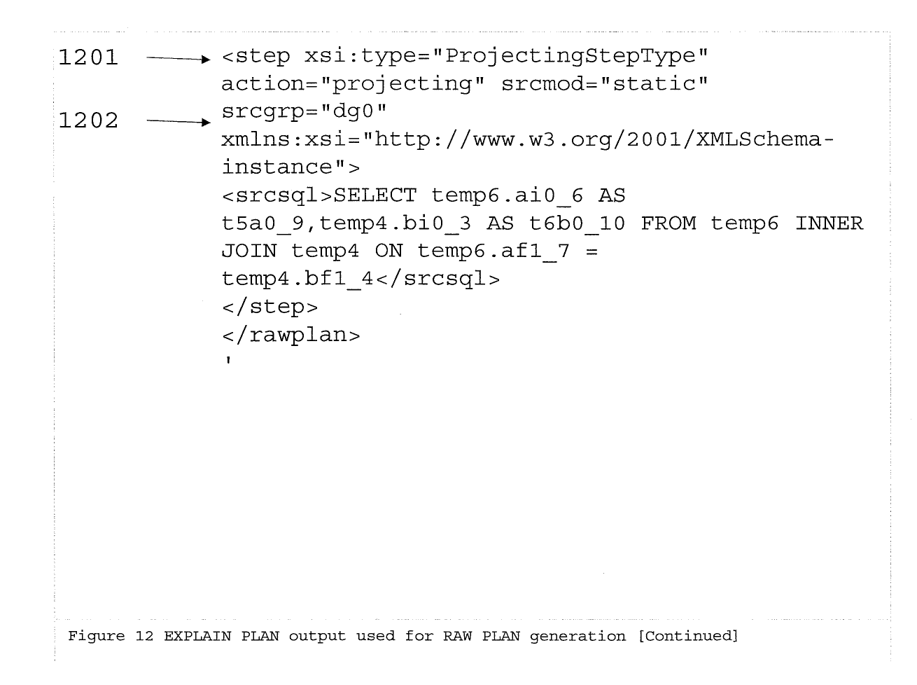

is FIG. 12 shows the last step in the query plan (1201) and this step performs a read from the temporary table temp6 which is on the storage group dg0 (1202).

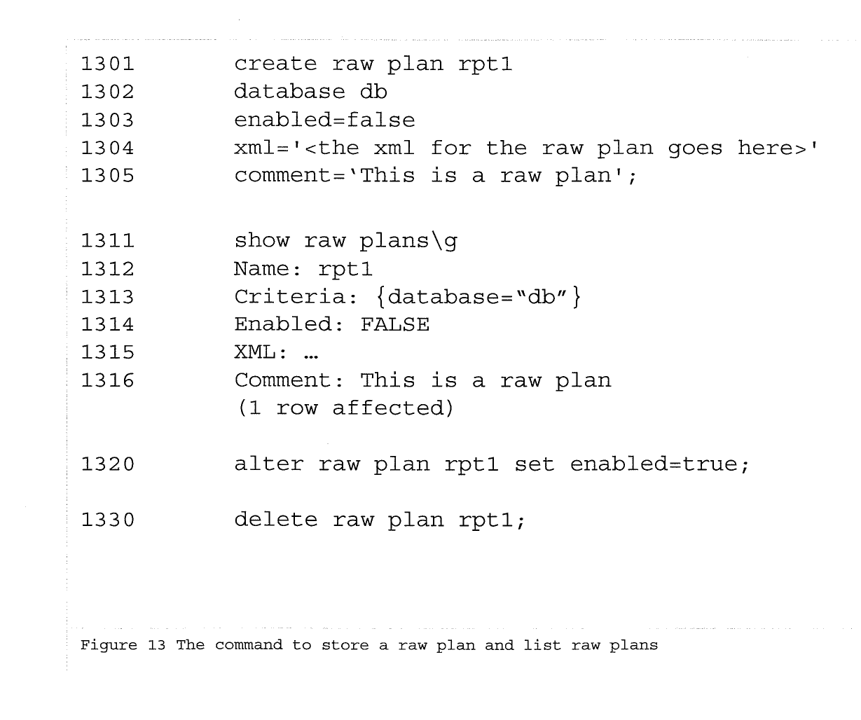

FIG. 13 illustrates the command to store a raw plan, list raw plans, and to alter and delete a raw plan. The command (1301) “CREATE RAW PLAN” names the raw plan being created as “rpt1” and provides the Criteria “database” with a value of “db” (1302) and marks the raw plan as disabled (1303). The command specifies a raw plan, specified in XML format (1304) and provides a comment with this raw plan (1305).

Returning attention to FIG. 3, the operation (304) that stores the raw plan in the raw plan cache causes the template of the input query, the raw plan and the criteria provided by the user to be stored into the raw plan cache (682 or 782). FIG. 13 illustrated one example of the criteria, the database “db”. The database(s), user(s), connection(s) or time(s) are some examples of criteria that a user may specify.

The criteria specified is any expression that the system can evaluate and the criteria associated with a raw plan are considered to be satisfied if the expression evaluates to TRUE and are considered to be not satisfied if the expression evaluates to other than TRUE. Without loss of generality, this expression could include logical operators, grouping operators, and so on. The degenerate criteria of “TRUE” or “FALSE” can also be specified. A default of either TRUE or FALSE may be inferred by the system if no criteria are specified.

The SHOW RAW PLANS command (1311) lists the raw plans known to the system. The output of the command (1312 through 1316) reflect information about the raw plan ‘rpt1’ (1312) just created above.

The “ALTER RAW PLAN” command can be used to modify a raw plan and as shown (1320) it can be used to enable a raw plan.

The “DELETE RAW PLAN” command can be used to delete a raw plan and as shown (1330) it can be used to delete the raw plan “rpt1”.

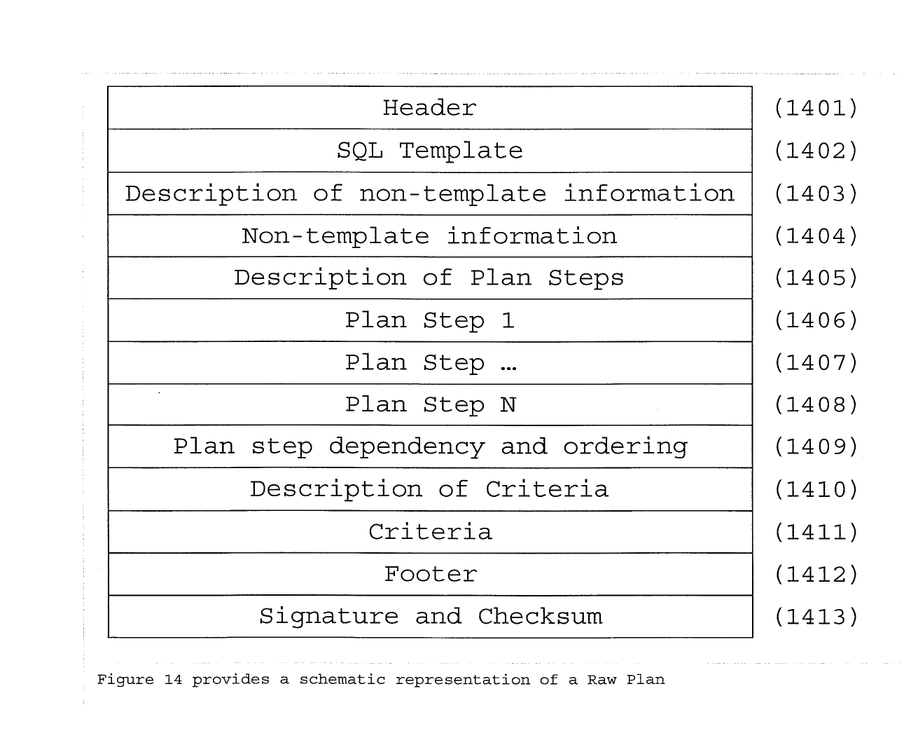

FIG. 14 provides a schematic diagram of an example Raw Plan. Each Raw Plan contains a Header (1401) that provides information about the Raw Plan. This includes information such as the version of the raw plan, the method of encoding and other information required by the system to process and understand the raw plan. The raw plan also contains the SQL Template (1402). When a query is submitted to the system, if the template of that query matches the template specified in the raw plan, then this raw plan can be considered for execution of that query. Non-template information is described (1403) including the names of those non-template elements, their data types and other information required to interpret the non-template information (1404). The raw plan also contains a series of plan steps and a description of these plan steps is provided (1405). This description includes such information as the number of plan steps. The various plan steps then follow (1406), (1407) and (1408). While plan steps are provided in a lineal form, they need not be executed only in that order. Plan step dependencies and ordering are then provided (1409). The criteria under which the Raw Plan is to be executed is first described (1410) and this description would include information required to decode the criteria (1411) itself. The raw plan ends with a footer (1412). To establish the validity of a Raw Plan, a signature and checksum may also be provided (1413). Not all raw plans will contain all of these elements and depending on the specific raw plan, additional elements may also be present.

Without loss of generality, one may use the techniques described above to provide the system with a raw plan and a query for immediate execution. Using this “Immediate Raw Plan” specification, a client application could further specify zero or more items of criteria, and whether or not the raw plan should be cached in the raw plan cache.

Assume that a user believes that a query plan generated by the system is aberrant for some reason and would like to debug this further. One avenue available to the user is to generate a query plan for the aberrant query and export that plan in the “Raw Plan” format. He can then send that Raw Plan with no data to a third party who can then cause a system to execute that query plan in response to a query. The third party can now insert arbitrary data into the database and attempt to recreate the effect of the aberrant query against that fictitious data and debug the problem with the system.

The third party can also suggest an alternative plan that the user should experiment with and he (or she) can do this by merely altering the Raw Plan and returning a modified Raw Plan to the user who is then able to install that into the Raw Plan cache and enable it.

The user could specify criteria that would instruct the system to only use the raw plan under test for (say) the present session. This would mean that a production system would continue to run unimpeded while the user can experiment with the raw plan and ensure proper functioning. Once a suitable Raw Plan is found, it can be installed into the Raw Plan cache with a less restrictive set of criteria which would expose it to (potentially) all users and the production system.

The criteria may also include references to non-template information and further restrict the applicability of the raw plan. For example, data skew is a common problem in database management systems. Assume that a table contains many rows with a particular attribute. However, the values for this particular attribute are “skewed” or “unequal”. The system may normally generate a good query plan for most values of that particular attribute but in the case of some particular values of that attribute, the query plan is sub- optimal. One could therefore include in the criteria, a specification that would cause the raw plan to be executed only when one of those sub-optimal attributes is specified in the user query.

It should be understood that the embodiments described above are but one example and the system and methods may be implemented in many different ways. In some instances, the various “data processors” described herein may each be implemented by a physical or virtual general purpose computer having a central processor, memory, disk or other mass storage, communication interface(s), input/output (I/O) device(s), and other peripherals. The general purpose computer is transformed into the processors and executes the processes described above, for example, by loading software instructions into the processor, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., processor, disk storage, memory, input/output ports, network ports, etc.) that enables the transfer of information between the elements. One or more central processor units are attached to the system bus and provide for the execution of computer instructions. Also attached to system bus are typically I/O device interfaces for connecting various input and output devices (e.g., keyboard, mouse, displays, printers, speakers, etc.) to the computer. Network interface(s) allow the computer to connect to various other devices attached to a network. Memory provides volatile storage for computer software instructions and data used to implement an embodiment. Disk or other mass storage provides non-volatile storage for computer software instructions and data used to implement, for example, the various procedures described herein.

Embodiments may therefore typically be implemented in hardware, firmware, software, or any combination thereof.

The computers that execute the processes described above may be deployed in a cloud computing arrangement that makes available one or more physical and/or virtual data processing machines via a convenient, on-demand network access model to a shared pool of configurable computing resources (e.g., networks, servers, storage, applications, and services) that can be rapidly provisioned and released with minimal management effort or service provider interaction. Such cloud computing deployments are relevant and typically preferred as they allow multiple users to access computing resources as part of a shared marketplace. By aggregating demand from multiple users in central locations, cloud computing environments can be built in data centers that use the best and newest technology, located in the sustainable and/or centralized locations and designed to achieve the greatest per-unit efficiency possible.

In certain embodiments, the procedures, devices, and processes described herein are a computer program product, including a computer readable medium (e.g., a removable storage medium such as one or more DVD-ROM's, CD-ROM's, diskettes, tapes, etc.) that provides at least a portion of the software instructions for the system. Such a computer program product can be installed by any suitable software installation procedure, as is well known in the art. In another embodiment, at least a portion of the software instructions may also be downloaded over a cable, communication and/or wireless connection.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical machines, virtual machines, cloud computers, and/or some combination thereof, and thus the computer systems described herein are intended for purposes of illustration only and not as a limitation of the embodiments.

Thus, while this invention has been particularly shown and described with references to example embodiments thereof, it will be understood by those skilled in the art that various changes in form and details may be made therein without departing from the scope of the invention as encompassed by the appended claims.

What is claimed is:

1. A database management system comprising:
a network interface, for receiving an incoming query from two or more client applications, the client applications operating on two or more client computers, and for providing a least one connection into the system for each such client application to provide incoming commands to the system that include at least the incoming query;
a group of one or more operational nodes for executing the incoming query as database operations, each operational node implemented as a logical collection of software components that execute on one or more physical or virtual machines;
a storage system for storing data;
a Query Parser for programmatically transforming the incoming query into template information and non-template information, wherein template information represents a parsed database command without manifest parameters specific to the incoming query, and the non-template information includes manifest parameters specific to the incoming query;
a Query Planner for programmatically transforming the incoming query into a Constructed Query Plan, the Constructed Query Plan including one or more database operations to be performed to implement the incoming query;
the system further receiving incoming commands from the client computers that include a command to store a Raw Query Plan in a Raw Plan Cache, the Raw Query Plan including (a) template information (b) one or more database operations to be performed to implement an incoming query with matching template information, and (c), additional criteria associated with the Raw Query Plan, wherein the additional criteria include an expression that when evaluated produces a value;
a Query Executor for executing the database operations in the Constructed Query Plans, and for executing the database operations in the Raw Query Plans, and for causing one or more results of executing the database operations to be sent to one or more client applications; and
the system further configured to, after receipt of the incoming query:
execute the Query Parser and extract the template information and the non-template information provided in the incoming query;
search the Raw Plan Cache to find a Raw Query Plan with template information matching the template information of the incoming query, and
when a Raw Query Plan with a matching template is found,
then evaluate the expression in the additional criteria, and when the expression evaluates to a predetermined value,
then operate the Query Executor to execute the matching template in the Raw Query Plan that was found in the search; and
only when a Raw Query Plan with a matching template is not found,
then
operate the Query Planner to construct a Constructed Query Plan, and
operate the Query Executor to execute the Constructed Query Plan.

2. (canceled)

3. The system of claim 1 whereby in response to a command that provides a Raw Query Plan and non-template information specific to a query associated with the Raw Query Plan, the Query Executor further executes the Raw Query Plan along with the non-template information specific to the incoming query.

4.-5. (canceled)

6. The system of claim 1 wherein the incoming commands include a command that enables a plan in the Raw Plan Cache.

7. The system of claim 1 wherein the incoming commands include a command that disables a plan in the Raw Plan Cache.

8. The system of claim 1 and wherein the incoming commands include a command that deletes a plan in the Raw Plan Cache.

9. The system of claim 1 wherein the additional criteria associated with the Raw Query Plan include one or more database(s), user(s), connection(s) or time(s).

10. (canceled)

11. A method for operating a database management system comprising:
receiving incoming database queries from two or more client applications via a network interface, the client applications operating on two or more user client computers;
providing a least one connection into the system for each such client application to provide incoming commands to the system, the incoming commands including at least the incoming queries;
storing data in a storage medium;
operating a group of one or more operational nodes for the further steps of:
receiving incoming commands from the client computers that include a command to store a Raw Query Plan in a Raw Plan Cache, the Raw Query Plan including (a) template information that represents a parsed database command without manifest parameters, (b) one or more database operations to be performed to implement incoming queries, and (c) additional criteria associated with the Raw Query Plan, the additional criteria further including an expression that when evaluated, generates a value
after receipt of an incoming query:
parsing the incoming query to extract template information and non-template information, the template information representing a parsed database command without manifest parameters specific to the incoming query, and the non-template information including manifest parameters specific to the incoming query;
searching the Raw Plan Cache for a stored Raw Query Plan having template information that matches the template information parsed from the incoming query;
upon finding a matching Raw Query Plan with matching template information;
then evaluating the expression associated with the matching Raw Query Plan to generate a value, and
when the expression evaluates to a predetermined value,
then operating a Query Executor to execute the matching Raw Query Plan, else
upon finding no Raw Query Plan with matching template information,
then
operating a Query Planner on one or more of the operational nodes, for further programmatically transforming the incoming query into a Constructed Query Plan, the Constructed Query Plan including one or more database operations to implement the incoming query; and
operating the Query Executor to execute the Constructed Query Plan.

12. (canceled)

13. The method of claim 11 additionally comprising in response to a command that provides a Raw Query Plan and non-template information specific to an incoming query associated with the Raw Query Plan, and further when the expression evaluates to a predetermined value, further operating the Query Executor to execute the Raw Query Plan along with the non-template information provided with the incoming query.

14.-15. (canceled)

16. The method of claim 11 wherein the incoming command enables a plan in the Raw Plan Cache.

17. The method of claim 11 wherein the incoming command disables a plan in the Raw Plan Cache.

18. The method of claim 11 wherein the incoming command deletes a plan in the Raw Plan Cache.

19. The method of claim 11 wherein the Raw Query Plan specifies one or more database(s), user(s), connection(s) or time(s) as the additional criteria.

20. (canceled)

21. The system of claim 1 wherein the Raw Query Plan further specifies two or more plan steps, a plan step dependency, and plan step ordering.

22. The method of claim 11 wherein the Raw Query Plan specifies two or more plan steps, a plan step dependency, and plan step ordering.

23. (canceled)

24. The system of claim 1 wherein:
the additional criteria provided with the Raw Query Plan reference non-template information in the incoming query or specific operational attributes of the executing environment within the system at a time of receipt of the incoming query.

25. (canceled)

26. The method of claim 11 wherein:
the additional criteria in the Raw Query Plan reference non-template information in the incoming query or specific operational attributes of the executing environment within the system at a time of receipt of the incoming query.

27. The system of claim 1 wherein the expression when evaluated further identifies a user, such that expression evaluates to a first value when evaluated for a first user and to a second value when the user is not the first user, and whereby the Raw Query Plan is executed when the user is a first user, and such that the Constructed Query Plan is executed only when the user is not the first user.

28. The system of claim 1 wherein the expression when evaluated further identifies a time of day, such that the Raw Query Plan is executed when a time of day is a first time, and such that the Constructed Query Plan is executed only when a time of day is a second time.

29. The system of claim 1 wherein the additional criteria provided with the Raw Query Plan is not used by the Query Planner to programmatically transform the incoming query into the Constructed Query Plan.

30. The method of claim 11 wherein the additional criteria provided with the Raw Query Plan is not used in programmatically transforming the incoming query into the Constructed Query Plan.
